(19) United States
(12) Patent Application Publication
(10) Pub. No.: US 2010/0062926 A1
(43) Pub. Date: Mar. 11, 2010

(54) ABSORBENT REGENERATION WITH FLASHED LEAN SOLUTION AND HEAT INTEGRATION

(76) Inventors: Simon Woodhouse, Strommen (NO); Pål Rushfeldt, Oslo (NO)

Correspondence Address: BIRCH STEWART KOLASCH & BIRCH, PO BOX 747, FALLS CHURCH, VA, 22040-0747, US

(21) Appl. No.: 12/516,093

(22) PCT Filed: Nov. 21, 2007
(86) PCT No.: PCT/NO07/00411

§ 371 Date: May 22, 2009

(30) Foreign Application Priority Data
Nov. 24, 2006 (NO) 20065411

(51) Int. Cl. B01J 20/34; C01B 31/20; B01D 19/00

(52) U.S. Cl. 502/55; 423/437.1; 96/201

(57) ABSTRACT

A method for regeneration of a rich absorbent having absorbed CO₂ (5) to give a regenerated, or lean absorbent (4) wherein the lean absorbent leaving the regenerator column is flashed (32) to produce a gaseous phase (33) that is compressed (34) and reintroduced into the regeneration column, and a liquid lean absorbent phase (4) that is heat exchanged (7) against the rich absorbent.

### TECHNICAL FIELD

The present invention relates to the field of CO₂ capture from a gas mixture. More specifically the present invention relates to CO₂ capture from a CO₂ containing gas, such as combustion gas from combustion of carbonaceous material or from other CO₂ liberating processes. Most specifically the present invention relates to an improved method and plant for regeneration of a CO₂ absorbent in a method and plant for capturing of CO₂.

### BACKGROUND

The continually increasing combustion of fossil fuel, such as coal, natural gas and oil, during the last centuries has resulted in an increase in the concentration of CO₂ in the atmosphere. The increasing concentration of CO₂ has caused concern due to the greenhouse effect caused by CO₂. The greenhouse effect is suspected already to have caused at least some of the changes in the climate that have been seen during the last decades, and is according to simulation models suspected to cause even more and potentially dramatic changes in the climate of planet earth.

This has caused a call for action from scientists, environmentalists and politicians throughout the world, to stabilize or even reduce the discharge of CO₂ from combustion of fossil fuel to the atmosphere. This may be achieved by capturing and safe depositing of CO₂ from the exhaust gas from thermal power plants and other plants where fossil fuel is combusted.

The captured CO₂ may be injected in sub terrain formations such as aquifers, oil wells for enhanced oil recovery or in depleted oil and gas wells for deposition. Tests indicate that CO₂ remains in the sub terrain formation for thousands of years and is not released into the atmosphere.

Capturing of CO₂ from a gas by means of absorption is well known and has been used for decades, e.g. for removal of CO₂ (and other acid gases) from produced natural gas at gas fields. The absorbents used or suggested in the prior art have been different aqueous alkaline solutions, such as potassium carbonate, see e.g. U.S. Pat. No. 5,528,811, and different amines, see e.g. U.S. Pat. No. 4,112,051, U.S. Pat. No. 4,397,660 and U.S. Pat. No. 5,061,465. Separation of CO₂ from exhaust gas from thermal power plants by means of an amine solution, is known e.g. from U.S. Pat. No. 4,942,734.

Common for these CO₂ capturing solution is that the gas mixture to be separated is introduced countercurrent to the aqueous adsorbent in an absorber column. The gas leaving the absorber column is CO₂ depleted (or acid gas depleted), whereas the CO₂ (or other acid gas) leaves the absorber column together with the absorbent. The absorbent is regenerated in the regenerator column and returned to the absorber column. Amine is regenerated by stripping the amine solution with steam in the regeneration column. The steam is generated in the reboiler at the base of the column.

As illustrated above CO₂ as such is well known in the art. However, there is a need for several improvements in the CO₂ capturing process to make CO₂ free or low CO₂ emission thermal power plants economically profitable.

The plants for capturing of CO₂ are relative large, complex and expensive constructions. It is therefore desired to reduce the size, complexity and cost of the plants.

Capturing of CO₂ is carried out at the expense of the efficiency of a thermoelectric power plant utilizing fossil fuel, so that the output of electrical power and/or medium temperature heat from a thermoelectric power plant is reduced. The reduced efficiency compared with a traditional plant makes these facilities less profitable. Improvements in the efficiency, i.e. reducing the energy cost in the CO₂ capturing process, are therefore sought.

The currently preferred absorbents are aqueous solutions of different amines. The commonly used amines are alkanol amines, such as e.g., diethanol amine, mono methyl ethanolamine, aminoethyl ethanolamine, 2-(Metylamino)etanol, MDEA as well as other amines known by skilled man in the art. The absorption of CO₂ to the amine absorbents is a reversible, exothermic reaction. Accordingly, heat has to be supplied to the regenerator column to reverse the absorption and release the CO₂.

The heat supplied to the regenerator column according to the state of the art, is supplied in reboiler where the absorbent is heated to a temperature typically from about 120 to 130° C. The absorbent in the reboiler may be heated by an electrical heat source but most commonly by a heat medium, such as e.g. medium temperature steam. The reboiler is the main consumer of medium temperature heat energy in the absorption/desorption cycle for CO₂ capturing. A reduction in the demand for medium temperature heat energy would improve the economy of the CO₂ capturing process.

GB 2,195,916 and U.S. Pat. No. 4,160,810 both describe cooling of the lean absorbent leaving the regenerator by flashing and is split in a liquid stream that is introduced into the absorber, and a gaseous phase that is reintroduced into regenerator. The pressure of the gaseous phase is boosted either by means of an ejector as described in GB 2,195,916, or by means of a compressor as described in U.S. Pat. No. 4,160,810.

EP 1,736,231 relates to an apparatus and method for recovering CO₂ from a gas mixture having a basic configuration according to the principles described above. Two heat exchangers are provided for heating the rich absorber before introduction into the regenerator, a first heat exchanger heating the rich absorbent against lean absorbent from the regenerator, and a second heat exchanger, heating the rich absorbent further against condensate from the reboiler. The use of the condensate from the reboiler to heat the rich absorbent reduces the heat loss from the heating of the reboiler as a greater part of the heat in the steam for the reboiler, is utilized.

The heat loss in the absorption and regeneration cycle of the CO₂ capturing process, is, however, still too high and improved plants and methods are still sought.

An objective for the present invention is thus to obtain a reduction in the reboiler duty, and thus a reduction in the demand for medium temperature energy, such as medium temperature steam.

### SHORT DESCRIPTION OF THE INVENTION

According to a first aspect, the present invention provides for a method for regeneration of a rich absorbent having absorbed CO₂, to give a regenerated, or lean absorbent, and CO₂, in which method a stream of rich absorbent is introduced into a regeneration column in which the absorbent flows downwards and countercurrent with steam generated by heating lean absorbent in a reboiler at the base of the regeneration column, where released CO₂ and steam are withdrawn from the top of the column and separated to give a stream of CO₂ that is removed, and condensed water that is recycled into the regeneration column,

where lean, or regenerated, absorbent is withdrawn from the base of the column, and where the rich absorbent is heated by heat a first heat exchanging against the lean absorbent and thereafter additionally heated by heat exchanging against a low temperature heat source before entering the regeneration column,

wherein the lean absorbent leaving the regenerator column is flashed to produce a gaseous phase that is compressed and reintroduced into the regeneration column, and a liquid phase that is heat exchanged against the rich absorbent. The combination of flashing of the lean absorbent leaving the regenerator, compressing the gaseous phase, introduction of the compressed gaseous phase into the regenerator as steam for stripping of absorbent, and further cooling the liquid phase after flashing against the rich absorbent before introduction into the regenerator, reduces the heat loss in the regenerator by recycling more of the heat energy back to the regenerator. Additionally, the liquid phase after flashing, or the lean absorbent to be returned to the absorber, is additionally cooled, which is advantageous for the absorption process. The combination also enables better use of low temperature heat. The combined effect of this process design is that the temperature profile in the column is improved and that heat normally transferred from lean amine to rich amine is maintained at the base of the stripper. The total result is an improved efficiency of the capturing process and an improved energy balance of the system.

According to a first embodiment of the first aspect, the compressed gaseous phase is mixed with water to cool and saturate the gaseous phase with steam before introduction into the regeneration column. After compression the gaseous phase normally has a temperature higher than required for introduction into the regeneration column. Introduction of water into the steam both cools the gas and saturates the steam with water to improve the utility of the compressed gaseous phase for regenerating the absorbent.

According to one embodiment, the water is separated from the withdrawn CO₂. By using water that is separated from the separated CO₂ for introduction into the compressed gaseous phase, the water balance of the overall system is maintained as no water is added or removed by the process.

According to a second aspect, the present invention relates to a method for capturing of CO₂ from a CO₂ containing gas, comprising introduction of a lean liquid absorbent and the CO₂ containing gas into an absorber in which the CO₂ containing gas is caused to flow countercurrent to the lean absorbent to produce a rich absorbent and a stream of CO₂ depleted gas, releasing the CO₂ depleted gas into the surroundings, withdrawing the rich absorbent from the absorber,

where the rich absorbent is introduced into a regeneration column in which the absorbent flows downwards and countercurrent with steam generated by heating lean absorbent in a reboiler at the base of the regeneration column,

where released CO₂ and steam are withdrawn from the top of the column and separated to give a stream of CO₂ that is removed, and condensed water that is recycled into the regeneration column,

where lean, or regenerated, absorbent is withdrawn from the base of the column, and where the rich absorbent is heated by heat a first heat exchanging against the lean absorbent and thereafter additionally heated by heat exchanging against a low temperature heat source before entering the regeneration column,

wherein the lean absorbent leaving the regenerator column is flashed to produce a gaseous phase that is compressed and reintroduced into the regeneration column, and a liquid lean absorbent phase that is heat exchanged against the rich absorbent. According to this aspect, the above described method for regeneration of an absorbent is implemented in a plant for capturing CO₂ including the advantages mentioned there for the method for capturing CO₂.

According to a third aspect the present invention provides for a regenerator for a liquid absorbent for CO₂ comprising a regeneration column, a rich absorbent line for introduction of rich absorbent into the regeneration column, withdrawal means for withdrawing lean adsorbent from the bottom of the regeneration column, a reboiler for heating of a portion of the withdrawn absorbent before reintroduction into the regeneration column for production of steam that is reintroduced into the column, a lean absorbent line for recycling of a portion of the absorbent withdrawn by withdrawal means to an absorber, a heat exchanger for heating rich absorbent against the withdrawn lean absorbent and a heat exchanger to additionally heat the heated rich absorbent against a low temperature heat source before the rich gas enters the regenerator, a gas withdrawal line for withdrawal of CO₂ and vapor from the top of the regeneration column, and separation means for separating the gas withdrawn from the top of the regeneration column in a CO₂ stream that is exported from the regenerator, and water that is recycled to the regeneration column, the regenerator further comprises flashing means, a steam withdrawal line connecting said flashing means with a compressor for compression of a withdrawn gaseous phase, a line for injecting the compressed gaseous phase into the regeneration column, and a lean absorbent line connecting the flashing means with the heat exchanger. The combination of flashing means, a compressor for compressing the gaseous phase after flashing, an injection line for injection the compressed gaseous phase into the regenerator, and the lean absorption line for the liquid phase, or lean absorbent line introducing the lean absorbent into the heat exchanger for further cooling of the lean absorbent, and heating of the rich absorbent, results in an improved efficiency of the process and in lower heat loss than for regeneration plants according to the prior art.

According to a first embodiment of this third aspect, the flashing means comprises a flash valve and a flash vessel.

According to another embodiment, the regenerator additionally comprises a de-superheater arranged between the compressor and the regeneration column, in which de-superheater the compressed steam is cooled and saturated with steam by introduction of water.

According to one embodiment, a line is provided from the separation means for leading water from the separation means to the de-superheater

According to a forth aspect, the present invention relates to a plant for capturing CO₂ from a CO₂ containing gas, comprising means for introducing a liquid lean absorbent and the CO₂ containing gas into an absorber in which the absorbent and the CO₂ containing gas are caused to flow countercurrent to produce a CO₂ depleted gas flow and a rich absorbent, means for releasing the CO₂ depleted gas flow into the surroundings, mans for withdrawing the rich absorbent and to introduce the rich absorbent into a regenerator, the regenerator comprising a regeneration column, a rich absorbent line for introduction of rich absorbent into the regeneration column, withdrawal means for withdrawing lean adsorbent from the bottom of the regeneration column, a reboiler for heating of a portion of the withdrawn absorbent before reintroduction into the regeneration column for production of steam that is reintroduced into the column, a lean absorbent line for recycling of a portion of the absorbent withdrawn by withdrawal means to an absorber, a heat exchanger for heating rich absorbent against the withdrawn lean absorbent and a heat exchanger to additionally heat the heated rich absorbent against a low temperature heat source before the rich gas enters the regenerator, a gas withdrawal line for withdrawal of CO₂ and vapor from the top of the regeneration column, and separation means for separating the gas withdrawn from the top of the regeneration column in a CO₂ stream that is exported from the regenerator, and water that is recycled to the regeneration column, further comprising flashing means, a steam withdrawal line connecting said flashing means with a compressor for compression of a withdrawn gaseous phase, a line for injecting the compressed gaseous phase into the regeneration column, and a lean absorbent line (4) connecting the flashing means with the heat exchanger. According to this aspect, the above described plant for regeneration of an absorbent is implemented in a plant for capturing CO₂ including the advantages mentioned there for the plant for capturing CO₂.

The term “low temperature heat source” or “low temperature heat medium” as used in the present description, is used to describe a heat source or a heat medium, such as water, steam, or other heat medium, having an outlet temperature from a heat exchanger below approx. 115° C., such as e.g. below 110° C. The outlet temperature from a heat exchanger for a low temperature heat source may be below 105° C., below 100° C. or below 95° C. The inlet temperature into a heat exchanger for a low temperature heat medium may be below 130° C., such as below 125° C.

The term “medium temperature heat” or “medium temperature heat medium” as used in the present description, is used to describe a heat source or heat medium, such as water, steam or other heat medium, having an outlet temperature form a heat exchanger above 120° C., such as above 125° C. or above 130° C. A medium temperature eat source or heat medium, normally has an inlet temperature to a heat exchanger of above 125° C., more preferably above 130° C.

A medium temperature heat medium may be steam at a temperature above 125° C., or above 130° C., which is condensed in a heat exchanger to produce condensate water at a temperature that is 1 to 10° C. lower than the inlet temperature of the steam. This condensate water may then be used as a low temperature heat medium for less temperature demanding processes.

The term “CO₂ containing gas” as used in the present description and claims, is any kind of combustion gas or other industrial gas flow including a level of CO₂ that is substantially higher than the level in the atmosphere. Typically, the CO2 containing gas is a combustion gas from a fossil fuel fired power plant.

The term “CO₂ depleted gas” or “CO₂ depleted stream” is used for a gas or gas stream from which a substantial part of the CO₂ has been removed. Typically more than 80%, more preferred more than 85% and most preferably more than 90% of the CO₂ introduced in the CO₂ containing gas is removed before the gas is released as a CO₂ depleted gas.

### SHORT DESCRIPTION OF THE FIGURES

FIG. 1 is a schematic diagram of a CO₂ capturing plant according to the state of the art, and

FIG. 2 is a schematic diagram of an embodiment of the present improved amine regeneration part of a CO₂ capturing plant.

### DETAILED DESCRIPTION OF THE PRESENT INVENTION

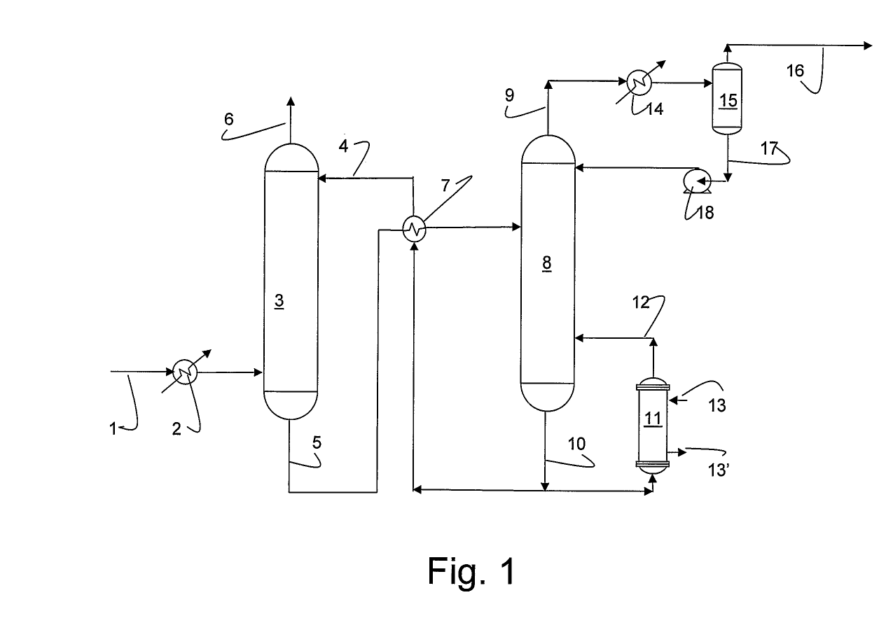

FIG. 1 illustrates a CO₂ capturing plant according to the prior art, where exhaust gas from combustion of carbonaceous fuel enters the CO₂ capturing plant through an exhaust line 1. The exhaust gas in line 1 is substantially cooled by utilization of the high temperature heat energy from the combustion for production of electrical energy. The temperature of the exhaust entering the CO₂ capturing plant through line is normally from about 120° C. to about 90° C. The exhaust gas from line 1 is optionally introduced into a cooling section in which it is saturated with water and cooled to a temperature e.g. from about 35° C. to about 60° C.

The cooled and humidified exhaust gas is then introduced into the lower part of an absorption tower 3 in which the exhaust gas flows from the bottom to the top of the absorption tower 3 countercurrent to a lean absorbent, i.e. absorbent that is stripped for CO₂, that is introduced into the upper part of the absorption tower through a lean absorbent line 4. Lean gas, i.e. exhaust gas where a substantial part of the CO₂ is removed, is removed through a gas exit line 6 at the top of the absorption tower, whereas rich absorbent, i.e. absorbent having absorbed CO₂, is removed from the absorption tower through a rich absorbent line 5.

The rich absorbent is heated against lean absorbent that is returned to the absorption tower in a heat exchanger 7 to a temperature typically in the range between 90 and 110° C., before the rich absorbent is introduced into a regeneration column 8. In the regeneration column 8 the rich adsorbent flows downwards, countercurrent to steam generated by heating some of the absorbent in a regeneration reboiler 11. Lean absorbent leaves the regenerator column through a lean absorbent outlet 10. A part of the lean absorbent in the outlet 10 is introduced into the regeneration reboiler 11 where it is heated to a temperature typically in the range between 120 and 130° C., to produce hot absorbent and steam which is re-introduced into the regenerator column through a line 12. The lean absorbent in the reboiler 11 is typically heated by means of electricity, or a heating medium, such as e.g. steam. When using a heating medium for heating the absorbent in the regeneration reboiler is introduced through a line 13 and removed through a line 13′. Steam as a heat medium for the reboiler is normally introduced as a high pressure steam at a temperature of 130° C. to about 140° C., and leaves through line 13′ as condensed steam at the same temperature. In other words, the energy transferred from the heat medium to the absorbent in the reboiler is the heat of condensation of the steam. The heating of the column from the bottom gives a temperature gradient at steady state from the bottom to the top of the column, where the temperature at the top is from 10 to 50° C. lower than at the bottom, depending on the actual design of the column. In a typical regeneration column the temperature at the bottom of the column is about 120° C. and the temperature at the top of the column is about from 10 to 50° C. lower than at the bottom of the column.

The lean absorbent in line 10 that is not introduced into the regeneration reboiler, is recycled back to the absorption column 3 through the line 4 and cooled in the heat exchanger 7 against rich absorbent in the line 5. In the heat exchanger 7 the relatively cold rich absorbent is heated against the relatively hot lean absorbent leaving the stripper at a temperature of about 120° C. Depending on the actual dimensioning and construction of the plant, the temperature of the rich amine leaving the heat exchanger 7 for the amine stripper may be from about 90 to about 110° C.

CO₂ released from the adsorbent and water vapor is withdrawn from the regenerator column 8 through a gas withdrawal line 9. The gas in the gas withdrawal line 9 is cooled in a reflux condenser 14 to condense water that is separated from the remaining gas, mainly comprising CO₂ in a CO₂ separator 15. CO₂ gas and some remaining water vapor is removed from the CO₂ separator 15 through a CO₂ line 16 for further treatment, such as drying, compression and deposition. The condensed water in the CO₂ separator is withdrawn through a line 17 and pumped back to the top of the regeneration column 8 by means of a pump 18.

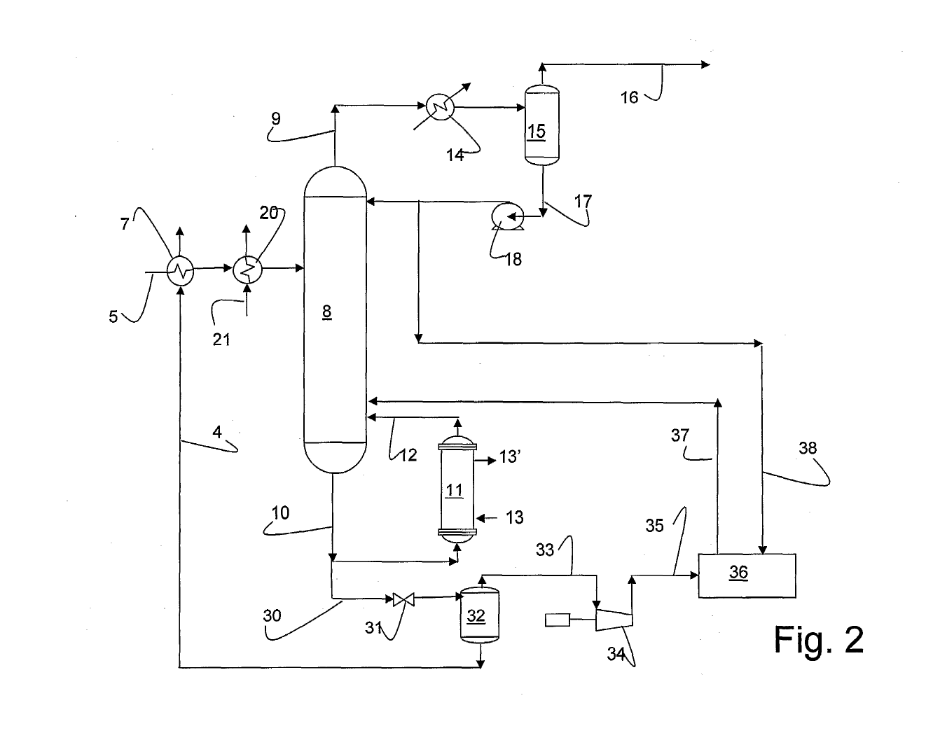

FIG. 2 illustrates an embodiment of a regeneration plant according to the present invention, for regeneration of an absorbent, in which a part of the lean absorbent leaving the reboiler 8 is flashed over a flash valve 31 and flash vessel 32 to give steam that is withdrawn from the flash vessel in a steam line 33, and lean absorbent that is returned to the absorber 3 via line 4. The gas generated in the flash vessel 32 mainly comprises steam and carbon dioxide, to remove more carbon dioxide from the absorbent before it is returned to the absorber.

The steam and CO₂ that is withdrawn through line 33 is then compressed in a compressor 34 to give a compressed, hot, unsaturated vapor in line 35. The steam in line 35 is then cooled and saturated by water in a de-superheater 36 in which water is introduced through a line 38 and mixed with the steam from line 35. The resulting water saturated steam from the de-superheater 36 is then returned and injected into to the stripper 8 through a line 37. The water introduced into the de-superheater may conveniently be a part of the water that is condensed in the separator 15. In the illustrated embodiment, the water in line 38 is withdrawn from line 17, conveniently after the pump 18.

Flashing of the lean absorbent over flash valve 31 and removal of vapor in separator 32, reduces the temperature of the lean absorbent. The rich medium leaving heat exchanger 7 may therefore have a temperature that is lower than the desired temperature for introduction into the regenerator column 8. An optional heat exchanger 20 heated by a low temperature heat medium in line 21, may therefore be provided to heat the rich absorbent to the desired temperature. The low temperature heat medium entering the heat exchanger 20 through line 21, may e.g. be the heat medium leaving the reboiler 11 in line 13′. The heat medium introduced into the reboiler in line 13 is preferably steam, whereas the heat medium leaving the reboiler in line 13′ is condensed water. Compressing the steam in line 33 increases both the temperature and the pressure of the steam, to produce hot, unsaturated vapor. The absorbent can be degraded by a temperature higher than about 130° C. The water added in the de-superheater 36 ensures that the steam that is introduced into the regeneration column in line 37 is saturated steam having a temperature of 120-130° C.

The term “steam” as used in the present description and claims, is, where appropriate, also intended to include steam that includes other gases, such as e.g. CO₂. By compressing the steam in line 33 and thereby adding heat, the low temperature and low pressure steam in line 33 is converted to medium temperature steam having a utility in the plant. Additionally, low temperature heat from the reboiler may find use in the heat exchanger 20. In a plant according to the state of the art, the low temperature heat medium, such as steam condensate leaving the reboiler, is cooled against water in a heat exchanger, and returned to a boiler for generation of medium temperature steam that is returned to the reboiler. The plant illustrated in FIG. 2 thus reduces the heat, or enegy loss, from the plant making it more energy efficient.

An exemplary plant according to FIG. 2 for capturing of CO₂ from the exhaust gas of a 400 MW gas fired power station with CO2 removal by MEA has been simulated and key data estimated.

According to the simulated model, the CO2 removal system removes 85% of the CO2 in the exhaust gas. The standard system demonstrated in FIG. 1 will require an amine regenerator reboiler with a duty of 152 MW. Heat is supplied in the form of saturated steam at 4 bara and 144° C. Steam condensate leaves the reboiler at 144° C. In a plant according to a state of the art, the condensate is cooled and pumped back to the power station for generation of steam. The amine regenerator operates at 1.9 bara.

According to the simulation model of the present invention, the lean absorbent is flashed over the valve 31 down to 1.05 bara. The vapor then generated is separated from the liquid and compressed up to 1.95 bara. Water is injected into the vapour to remove the superheat. The vapor is then introduced into the stripper column at the base. The reboiler duty is reduced to 110 MW, a reduction of 42 MW. The vapor compressor has a power consumption of 3.3 MW.

The lean absorbent exits the flash vessel at 102° C. Therefore, the rich amine cannot be heated above 100° C. in the amine/amine exchanger. It is therefore possible to use the steam condensate from the reboiler to heat the rich amine. This will reduce the reboiler duty even more.

Accordingly, the use of the lean amine flash to generate steam according to the present invention, makes it possible to reduce the steam requirement for the regenerator from 152 MW to 110 MW and thereby reducing the steam requirement of the regenerator by 28%. Even though this saving is at the cost of an electrical power consumption for compression of 3.3 MW, the savings are significant.

1-16. (canceled)

17. A method for regeneration of a rich absorbent having absorbed CO₂, to give a regenerated, or lean absorbent, and CO₂, the method comprising the steps of
a) introducing a stream of rich absorbent into a regeneration column in which the absorbent flows downwards and countercurrent with steam generated by heating lean absorbent in a reboiler at the base of the regeneration column,
b) withdrawing released CO₂ and steam from the top of the column and separation of the withdrawn CO₂ and steam to give a stream of CO₂ that is removed, and condensed water that is recycled into the regeneration column,
c) withdrawing lean, or regenerated, absorbent from the base of the column,
d) flashing the withdrawn lean absorbent to produce a gaseous phase that is compressed and reintroduced into the regeneration column, and a liquid lean absorbent phase,
e) heating the rich absorbent by a first heat exchanging against the flashed lean absorbent,
f) heating of the rich absorbent after being heat exchanged against the lean absorbent by heat exchanging against a heat medium having an inlet temperature lower than 130° C., and
g) introducing the heated rich absorbent into the regeneration column.

18. The method according to claim 17, wherein the compressed gaseous phase is mixed with water to cool and saturate the gaseous phase with steam before the compressed gaseous phase is introduction into the regeneration column.

19. The method according to claim 18, wherein the compressed gaseous phase is cooled to a temperature of 120 to 130° C. before introduction into the regeneration column.

20. A method for capturing of CO₂ from a CO₂ containing gas, comprising introduction of a lean liquid absorbent and the CO₂ containing gas into an absorber in which the CO₂ containing gas is caused to flow countercurrent to the lean absorbent to produce a rich absorbent and a stream of CO₂ depleted gas, releasing the CO₂ depleted gas into the surroundings, withdrawing the rich absorbent from the absorber, wherein the rich absorbent is regenerated to give a stream of CO₂ and lean absorbent according the method of claim 17.

21. The method according to claim 20, wherein the compressed gaseous phase is mixed with water to cool and saturate the gaseous phase with steam before introduction into the regeneration column.

22. The method according to claim 21, wherein the compressed gaseous phase is
cooled to a temperature of 120 to 130° C. before introduction into the regeneration column.

23. A regenerator for a liquid absorbent for CO₂ comprising a regeneration column, a rich absorbent line for introduction of rich absorbent into the regeneration column, withdrawal means for withdrawing lean adsorbent from the bottom of the regeneration column, a reboiler for heating of a portion of the withdrawn absorbent before reintroduction into the regeneration column for production of steam that is reintroduced into the column, a lean absorbent line for recycling of a portion of the absorbent withdrawn by withdrawal means to an absorber, a heat exchanger for heating rich absorbent against the withdrawn lean absorbent and a heat exchanger to additionally heat the heated rich absorbent against a low temperature heat source before the rich gas enters the regenerator, a gas withdrawal line for withdrawal of CO₂ and vapor from the top of the regeneration column, and separation means for separating the gas withdrawn from the top of the regeneration column in a CO₂ stream that is exported from the regenerator, and water that is recycled to the regeneration column, wherein that it further comprises flashing means, a steam withdrawal line connecting said flashing means with a compressor for compression of a withdrawn gaseous phase, a line for injecting the compressed gaseous phase into the regeneration column, and a lean absorbent line connecting the flashing means with the heat exchanger.

24. The regenerator according to claim 23, wherein the flashing means comprises a flash valve and a flash vessel.

25. The regenerator according to claim 23, additionally comprising a de-superheater arranged between the compressor and the regeneration column, in which the de-superheater the compressed steam is cooled and saturated with steam by introduction of water.

26. The regenerator according to claim 25, wherein a line is provided from the separation means for leading water from the separation means to the de-superheater.

27. A plant for capturing CO₂ from a CO₂ containing gas, comprising means for introducing a liquid leans absorbent and the CO₂ containing gas into an absorber in which the absorbent and the CO₂ containing gas are caused to flow countercurrent to produce a CO₂ depleted gas flow and a rich absorbent, means for releasing the CO₂ depleted gas flow into the surroundings, means for withdrawing the rich absorbent and to introduce the rich absorbent into a regenerator according to claim 23.

28. The plant according to claim 27, wherein the flashing means comprises a flash valve and a flash vessel.

29. The regenerator according to claim 27, additionally comprising a de-superheater arranged between the compressor and the regeneration column, in which de-superheater the compressed steam is cooled and saturated with steam by introduction of water.

30. The regenerator according to claim 29, wherein a line is provided from the separation means for leading water from the separation means to the de-superheater.
